(19) United States
(12) Patent Application Publication
(10) Pub. No.: US 2022/0005123 A1
(43) Pub. Date: Jan. 6, 2022

(54) METHODS AND SYSTEMS FOR MANAGING DIGITAL GROUPS AND CLAIM ALLOCATIONS IN DIGITAL A PEER-TO-PEER INSURANCE NETWORK

(71) Applicant: PINEAPPLE TECH, INC., Hartford, CT (US)

(72) Inventors: Ndabenhle Ngulube, Sandton (ZA); Matthew Smith, Sandton (ZA); Marnus Van Heerden, Johannesburg (ZA)

(21) Appl. No.: 17/291,445

(22) PCT Filed: Jan. 6, 2020
(86) PCT No.: PCT/IB2020/050064

§ 371 Date: May 5, 2021

(30) Foreign Application Priority Data
Nov. 5, 2018 (ZA) 2018/07381

(51) Int. Cl. G06Q 40/08

(52) U.S. Cl. CPC G06Q 40/08

(57) ABSTRACT

Methods and systems for managing digital groups and claim allocations in digital a peer-to-peer insurance network, the network including a plurality of members each having an electronic member account, including establishing a group comprising a subset of the members of the network, adding a member of the network to the group by associating the member account of the new group with the group, determining, for the new group member account, a member general risk weighting, a group risk factor adjustment and a network risk factor adjustment, and using same to determine liability of the new group member account when a claim originates from within or outside the group; and adjusting the risk factor adjustments of the new group member general risk weighting in response to another member being added/leaving the group or network, or in response to a change in risk of a member account in the group.

### CROSS REFERENCE TO RELATED APPLICATIONS

This application is a National Stage application of International Patent Application No. PCT/IB2020/050064, filed on Jan. 6, 2020, which claims priority to South Africa Provisional Patent Application No. 2018/07381, filed on Nov. 5, 2018, the entire contents of each application above is incorporated herein by reference in its entirety to the fullest extent permitted by applicable law.

### TECHNICAL FIELD OF THE INVENTION

The invention relates, broadly, to insurance. More specifically, the invention relates to a computer-implemented method of managing a group in a peer-to-peer insurance network. The invention also relates to a system for managing a group in a peer-to-peer insurance network. The invention further relates to an associated computer program product.

### BACKGROUND OF THE INVENTION

The concept of a cell captive arrangement is well-known in the insurance industry. Essentially, in a cell captive arrangement, a participant chooses to self-insure by forming or becoming part of a so-called cell within a larger insurance group. Each cell is typically ring-fenced, i.e. no cross-subsidization is allowed, and each cell must usually be individually solvent.

In the Inventors' experience, cell captives are established manually and on a case-by-case basis. In other words, each cell captive has its own set of rules. In the cell captives of which the Inventors are aware, members contribute approximately the same quantum and risk type to a pool associated with the cell captive. Some of these systems rely on step-based rules, e.g. for a group of up to 30 members, 10% of each member's premium is allocated to savings and the other 90% is allocated to insurance, for a group of more than 30 and up to 50 members, 20% of each member's premium is allocated to savings and the other 80% is allocated to insurance, and so forth.

The Inventors have found that current methods of establishing and operating cell captives have several limitations and/or drawbacks.

Firstly, cell captives are usually governed by ad hoc rules and relatively complicated structures, as such, there is no general system that is available to members of the public to form their own cell captives. Secondly, existing arrangements are relatively rigid and do not make enough provision for different risk types, risk profiles, group sizes, and the like. Furthermore, existing systems may require significant manual (i.e., human) administration which may be difficult and/or time-consuming. These issues may reduce the appeal of cell captives and/or may prohibit large-scale consumer adoption.

Embodiments of the present invention aim to address the above issues, at least to some extent.

### SUMMARY OF THE INVENTION

According to one aspect of the invention, there is provided a computer-implemented method of managing a digital group in a digital peer-to-peer insurance network, the digital network including a plurality of members each having a member account, wherein the method comprises: establishing, e.g., by a group establishing module or other module or logic, a digital group which is configured to include a subset of the members of the digital network; adding, e.g., by a group administration module or other module or logic, a member of the network to the group by associating the member account of the member with the group; determining, e.g., by a risk factor module or other module or logic, for the member account of the member added to the group, a group risk factor and a network risk factor, these factors are used to determine liability of the new group member account in the event of a claim originating from a member account which forms part of the same group (in-group claimant), and determine the liability of the new member account in the event of a claim originating from a member account which does not form part of the same group (non-group claimant); in some embodiments, the group risk factor may be used to determine liability of the member account in the event of a claim originating from a member account which forms part of the group, and wherein the network risk factor is used to determine liability of the member account in the event of a claim originating from a member account which does not form part of the group; and adjusting, by the risk factor module, the group risk factor and/or the network risk factor of the member of the group in response to another member being added to or leaving the group or network, or in response to a change in risk associated with a member account in the group.

The method may include determining a “group risk factor” and/or a “network risk factor” for the member account of each member of the group. The method may include, in response to a new member being added to the group, determining a group risk factor and/or a network risk factor for the member account of the new member and adjusting the group risk factor and/or network risk factor of the member account of each other member of the group. In response to a member leaving the group, the group risk factor and/or network risk factor of the member account of each of the remaining members of the group may be adjusted. Likewise, group and network risk factors may be adjusted in response to risk being added or reduced by a member of the group (i.e. in response to a change in risk associated with a member account).

The group risk factor may be determined by aggregating with weightings a general risk weighting of the member account of a member with the “general risk weighting” of one or more of the member accounts of members who are part of the group. An “additional risk weighting” may be added to the general risk weighting to arrive at the group risk factor. In some embodiments, the general risk weighting may be adjusted by the group risk factor increase and network risk factor decrease to provide an adjusted general risk weighting for the member.

The additional risk weighting may be determined based on risk weightings of one or more other member accounts of the group, e.g., based on relative risk weightings in the group.

The network risk factor may be determined by aggregating with weightings the general risk weightings of all member accounts in the network and deducting the group risk factor from this aggregation.

In some embodiments, a “risk weighting deduction” may be applied to arrive at the network risk factor and the “additional risk weighting” referred to above may, in some embodiments, be substantially equal but opposite to the “risk weighting deduction”.

The member accounts may be digital electronic wallets (or e-wallets) used in the digital peer-to-peer insurance network. The “general risk weighting” for a particular member account may be a risk weighting based on one or more factors, such as a premium paid into the wallet and/or an item insured, and/or a sum insured (level of coverage for the item insured) and/or any other measure of risk.

The adjusting step may include, for each new member added to the group or each additional risk added by existing members of the group, allocating a “risk weighting deduction” to the network risk factors of the members of the group and adding an “additional risk weighting” to the group risk factors of the members of the group.

The method may include determining, an independence level of the group. The independence level may be determined based on a level of exposure of members of the group to claims originating from member accounts outside of the group. In some embodiments, the independence level of the group may be adjusted in a linear fashion from 0 or close to 0 to a maximum at which the group is designated a full cell captive.

The method may include linearly increasing the group risk factor of a member's account and linearly decreasing the network risk factor of a member's account, by the risk factor module, as more member accounts are added to the group or additional risk is added by existing member accounts of the group. In this way, the independence level of the group may be adjusted linearly and when maximized, the group may form a cell captive.

In some embodiments, therefore, once the group has sufficient members, the network risk factors of the member accounts of the group may be zero, indicating that the group is self-sustaining and able to function as a cell captive within the network. The independence level may then be designated as having reached the maximum, e.g., a level of 100/100%.

The method may include identifying and/or measuring, by the group administration module and/or the risk factor module, that the independence level of the group has reached the maximum, or cell captive state.

Until the maximum independence level is reached, as the group grows in size, there may be a gradual, e.g., linear, transfer towards it where the member of the group is partially exposed to a general community of the network and partially exposed to group.

The method may include determining, e.g., by a group administration module and/or a risk factor module or other module/logic, a level of liability of each member of the group for a claim originating from a member account which does form part of the group and originating from a member account which does not form part of the group, respectively, based on the independence level of the group, and in the event of a claim originating from a member account which does form part of the group, the group administration module and/or the risk factor module may increase the liability of the member of the group for this claim as the independence level of the group grows, and in the event of a claim originating from a member account which does not form part of the group, the group administration module and/or the risk factor module may decrease the liability of the member of the group for this claim as the independence level of the group grows.

The method may include storing the member accounts of the members of the group in association with each other in the database.

The functionality of one or more of the modules or logic described herein, e.g., the group establishing module, the group administration module and/or the adjusting module, may be provided by a server, e.g., a remotely accessible server. The server may include a server computer or a cluster of computers, or any suitable computer system or systems, which may be in the same or different locations.

Communications between members of the network and the server may be carried out via a web-based platform or other communication network. The platform may be provided by a mobile software application, website, or the like. Communications may also be carried out using native mobile software.

According to another aspect of the invention, there is provided a system for managing a digital group in a digital peer-to-peer insurance network, the digital network including a plurality of members each having a digital member account, wherein the system includes a server which comprises: a group establishing module for establishing a group which is configured to include a subset of the members of the network; a group administration module for adding a member of the network to the group by associating the member account of the member with the group; and a risk factor module for determining, for the member account of the member added to the group, a group risk factor and a network risk factor, wherein the group risk factor is used to determine liability of the member account in the event of a claim originating from a member account which forms part of the group, and wherein the network risk factor is used to determine liability of the member account in the event of a claim originating from a member account which does not form part of the group, wherein the risk factor module is configured to adjust the group risk factor and/or the network risk factor of the member of the group in response to another member being added to or leaving the group or network, or in response to a change in risk associated with a member account in the group.

The server may include a storing module for storing data relating to the member accounts in a database. The system may include or be communicatively coupled to the database.

According to a further aspect of the invention, there is provided a computer program product including at least one computer-readable medium having stored thereon at least one computer program which, when executed by a computer or a computerized system, causes the computer or computerized system to perform a method of managing a group in a peer-to-peer insurance network, substantially as described above. The computer-readable medium may be a non-transitory computer-readable medium.

### BRIEF DESCRIPTION OF THE DRAWINGS

The invention will now be further described, by way of example, with reference to the accompanying drawings.

FIG. 1 is a schematic example of a digital peer-to-peer insurance network which is managed by an embodiment of a system, according to embodiments of the present invention.

FIG. 2 is a flow diagram illustrating steps that may be performed in an example of a method of managing a group in a digital peer-to-peer insurance network, according to embodiments of the present invention.

FIG. 3A is a conceptual illustration of exemplary groups in a digital peer-to-peer insurance network, according to embodiments of the present invention.

FIG. 3B is an exemplary illustration of the relationship between group size and independence level and group and network risk factors, which may be employed in embodiments of the invention to scale a group to a point where it is designated a cell captive, according to embodiments of the present invention.

FIG. 3C is an alternative conceptual illustration of exemplary groups in a digital peer-to-peer insurance network having different relative sizes and claim exposure, according to embodiments of the present invention.

FIG. 3D is graph of a family of line graphs or curves for % of member premiums allocated to claims (y-axis) vs. independence level of group (x-axis), which illustrates this relationship for a series of different loss ratios (0 to 100%) of a group, according to embodiments of the present invention.

FIG. 4 is a schematic diagram of a computer within which a set of instructions, for causing the computer to perform any one or more of the methodologies described herein, may be executed, according to embodiments of the present invention.

FIG. 5A is a series of screen illustrations showing an example of how a digital group may be created and modified, according to embodiments of the present invention.

FIG. 5B is a flow diagram of one embodiment of a group creation and adjustment logic, according to embodiments of the present invention.

FIG. 6A is a flow diagram of one embodiment of one or more of the components or modules in FIG. 1, in accordance with embodiments of the present disclosure.

FIG. 6B is a detailed flow diagram of a portion of FIG. 6A, in accordance with embodiments of the present disclosure.

FIG. 7 is a flow diagram of one embodiment of one or more of the components or modules in FIG. 1, in accordance with embodiments of the present disclosure.

FIG. 8 is a flow diagram of one embodiment of a claim allocation logic, in accordance with embodiments of the present disclosure.

FIG. 9 is a flow diagram of one embodiment of a premium return logic, in accordance with embodiments of the present disclosure.

FIG. 10 is a flow diagram of one embodiment of a premium return logic, in accordance with embodiments of the present disclosure.

FIG. 11 is a table showing various values of parameters associated with members accounts, in accordance with embodiments of the present disclosure.

FIG. 12 is a table showing various values of parameters associated with members accounts, in accordance with embodiments of the present disclosure.

### DETAILED DESCRIPTION

The following description of the invention is provided as an enabling teaching of the invention. Those skilled in the relevant art will recognize that many changes can be made to the embodiments described, while still attaining the beneficial results of the present invention. It will also be apparent that some of the desired benefits of the present invention can be attained by selecting some of the features of the present invention without utilizing other features. Accordingly, those skilled in the art will recognize that modifications and adaptations to the present invention are possible and can even be desirable in certain circumstances, and are a part of the present invention. Thus, the following description is provided as illustrative of the principles of the present invention and not a limitation thereof.

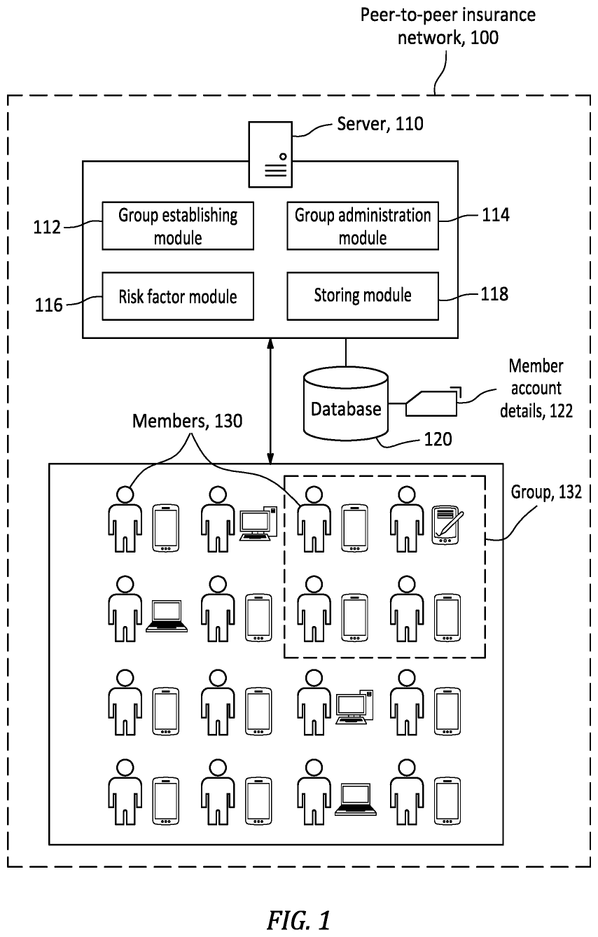

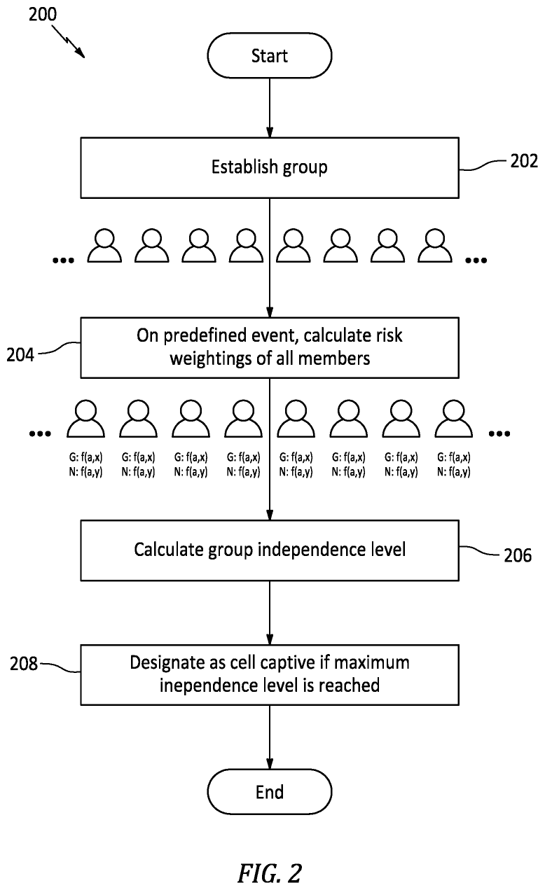

FIG. 1 illustrates an example of a peer-to-peer insurance network 100. The network 100 is managed by a remotely accessible server (hereafter, “the server 110”) which includes the following functional modules: a group establishing module 112, a group administration module 114, a risk factor module 116 and a storing module 118. The functionality of these modules 112, 114, 116, 118 will be described in greater detail below, with reference to FIG. 2.

The server 110 is communicatively coupled to a database 120 which stores member account details 122 associated with member accounts of the members 130 of the network 100.

Each of the members 130 can communicate with the server 110 using a suitable electronic communications device (e.g. a mobile phone, laptop or personal computer). Typically, the members 130 may communicate with the server 110 via a web-based platform, e.g. a website or a mobile software application.

The network 100 is a digital risk sharing network in the sense that the members 130 pool their insurance premiums together to insure against risks. Each member 130 has a member account in the form of a digital “wallet” (or e-wallet). The risk factor module 116 assigns a risk factor, or liability factor, in the form of a risk weighting to each member 130. This risk weighting is typically based on the premium of the member in question, but may be based on other factors, e.g. total insured sum or risk score. This weighting will be referred to as a member's “general risk weighting” below.

The general risk weighting determines how much of a claim a particular member's wallet should contribute when one of the members of the network 100 claims. Accordingly, liability to pay for claims is distributed across the network 100. For example, when a claim occurs, each member 130 may cover a portion of the claim based on the weight of their premium relative to the whole pool.

Members 130 typically also pay a fee associated with reinsurance, which may be a percentage (e.g., 15%) of the member premium. Other values and calculations for a member's reinsurance fee may be used if desired. In some embodiments, a member's reinsurance fee (or percentage) may vary based on the group the member is in). This ensures that, should there be insufficient funds in the pool of funds formed by the wallets in the network 100, a reinsurer will cover the shortfall. For instance, if a member has R100 in his or her wallet and, based on his or her risk weighting, the member is allocated R200 for a claim, the wallet will decrease to RO and the reinsurer will cover the remaining R100 (as well as the shortfalls associated with the other wallets in the network).

In some embodiments, unused funds in a member's wallet may be returned to the member periodically, as discussed further herein.

The server 110 and database 120 provide a system for establishing and managing groups (e.g. the group 132) consisting of subsets of the members 130. The flow diagram 200 of FIG. 2 illustrates an example of the manner in which a group can be established and managed in the digital network 100. Specifically, in this example, the system allows for the scaling of a group into a cell captive arrangement by adjusting an independence level of the group in the manner described below.

At a first stage (or step or block) 202, the group establishing module 112 of the server 110 establishes a group 132. The group 132 is configured to include a subset of the members 130 of the network 100, allowing this subset of members 130 partially or completely to function as a cell captive. Members 130 may typically create their own groups, e.g., friends or acquaintances may form a group 132 via the mobile software application or website referred to above in an attempt to protect themselves at least partially from claims of those outside of their group. Alternatively, in some implementations, groups 132 may be created without input from members and/or members may not individually decide which groups to join.

Members 130 are then added to the group 132, using the group administration module 114 (or other modules or logic), during a so-called “transition period”, in which the group 132 still forms part of (and has shared liability with) the “mutual” (larger community created by the network 100), but also has some features of a cell captive.

On a predefined event, the risk factor module 116 calculates/adjusts the general risk weighting of each member added to the group (at stage or block 204). The predefined event may be one or more of: creation or dissolution of a group, addition or removal of a member of the group or a member of the network 100, change in risk associated with a member account of a member of the group and/or incoming claim liability. More specifically, the risk factor module 116 is configured to determine a group risk factor and a network risk factor for each member in the group.

The group risk factor is used to determine liability of the member account of a particular member of the group in the event of a claim originating from a member account which forms part of the group, while the network risk factor is used to determine liability of the member account in the event of a claim originating from a member account which does not form part of the group. In particular, an increase in the group risk factor results in an increase in liability of a claim from within the group and an increase in the network risk factor results in an increase in the liability of a claim from the network. In some embodiments, both group risk factor and network risk factor may be use to determine liability of a claim within and outside the group.

In this example, once members join a group they are all connected to each other. The storing module 118 stores the member accounts of the members of the group in association with each other in the database 120. The risk factor module 116 considers the general risk weighting of each member (which was determined when the member became part of the network 100 and before joining the group) relative to the general risk weightings of the other members of the group. For each member, based on these relative weightings, the group risk factor is calculated by allocating an additional risk weighting (or points increase), based on the additional risk/member added to the group, to the general risk weighting for all claims that originate from inside of the group. Furthermore, the network risk factor is calculated by allocating a risk weighting (or points) deduction to the general risk weighting for all claims that originate from outside of the group. Due to the probability of claims being higher from the network 100 as opposed to a given member's group, the decrease in the network risk factor experienced over many claims is substantially equal and opposite to the increase in the group-risk factor. This ensures the system is fair and balanced. As a result, in the aggregate, the risk weighting deduction taking place on the network risk factor is substantially equal but opposite to the additional risk weighting increase on the group risk factor.

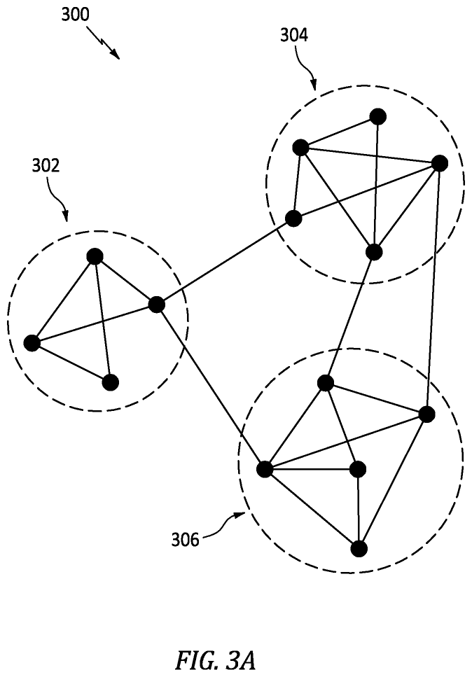

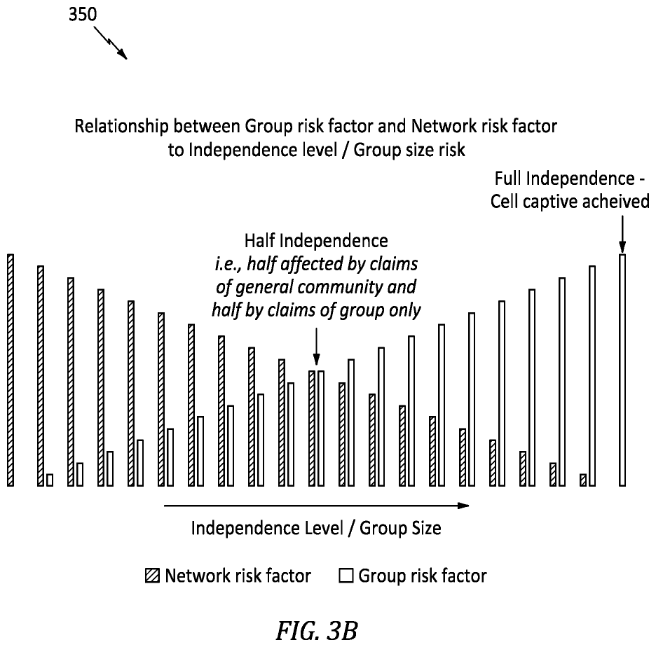

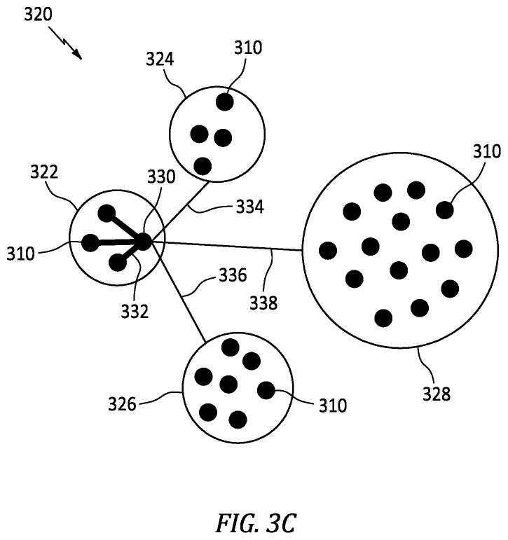

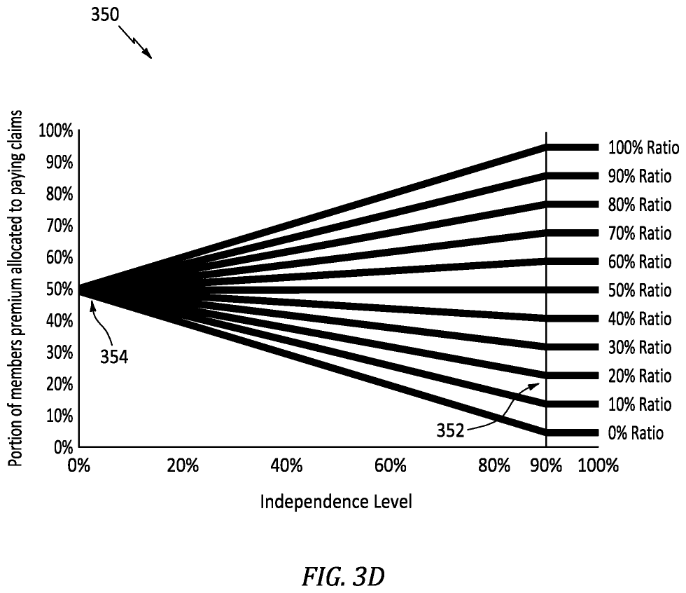

In some embodiments, as more members are added to the group, group risk factors of the members in the group may be linearly increased while network risk factors are linearly decreased (an example of this is illustrated in FIG. 3B).

The group administration module 114 monitors the group and calculates an independence level of the group (stage 206), which determines how liable members of the group are for both claims originating from outside of the group (based on the network risk factors) and for claims originating from inside of the group (based on the group risk factors).

Once the group has sufficient members or otherwise has sufficient resources to operate independently, the network risk factors of the member accounts of the group will be zero, indicating that the group has reached a maximum level of independence and is self-sustaining and able to function as a cell captive within the network 100 (stage or block 208). In other words, once the group is large enough, the deduction allocated to the general risk weighting in respect of “outside claims” will be equal to (or more than) the initial allocation given to the member from the general community, i.e. the general risk weighting.

At this point, the group is designated by the group administration module 114 as a “virtual cell captive” which is completely protected from claims outside of the group. If the network risk factor of a member account is zero, the member account has no liability in the event of a claim originating from a member account which does not form part of the group, and is liable only in the event of a claim originating from a member account in the group.

Naturally, if one or more members leave the group, the network risk factors of the remaining members may be reinstated or raised to higher than zero, such that the group becomes liable to the rest of the network 100 again.

Embodiments of the invention allow for the continuous shift/scaling from “general community” to “complete cell captive” to take place gradually, e.g. in a linear fashion, and thus allows flexibility for members to create their own virtual cell captives over time by building them up to a point of independence, while they are still fully covered for any losses for the entire transition period. This is illustrated conceptually by the topology 300 of FIG. 3A, which shows three groups 302, 304, 306 that are all still in transition and not yet fully captive. In FIG. 3A, members of the groups are shown as dots in the groups, and lines between members indicate connections between members. As discussed herein, in general, within a group, each member is connected to each other member in the group. The relationship of this linear transition is illustrated in the graph 350 of FIG. 3B. This relationship may also be non-linear if desired, provided it is a continuous transition (not step-wise changes), as described herein.

Referring to FIG. 3C, a diagram 320 shows an alternative view of a topology of groups. In that case, groups 322, 324, 326, and 328 are four groups that are still in transition, and not fully captive (similar to FIG. 3A), having members 310, where group 322 has a member 330 which is making a claim, and they have a group size order from largest to smallest of: 328, 326, 324, 322. In that case, the largest portion of the liability will be paid by the members of the group with the claimant 322 (widest connecting lines 332—within the group 322), the next largest claim portion will be paid by members of the group 324 (next smallest group) (next narrower connecting line 334), the next largest claim portion will be paid by members of the group 326 (next narrower connecting line 336), the remaining final (smallest) claim portion will be paid by members of the group 328 who are the largest group and therefore protected more from the claim of the member outside their group (narrowest connecting line 338). The connecting lines show the general liability relationship between the claimant member 330 and the other groups members. Also, while members of a given group will, as a class, have less contribution to a claim than the other groups, each member's contribution to a given non-group claim will be different based on a given members general risk weighting (as adjusted based individual risk factors described herein).

Referring to FIG. 3D, a series of ten line graphs 350 is shown to illustrate certain aspects of how groups work in accordance with the present disclosure. The X-axis represents how independent the group is, and the Y-axis represents the allocation of claims as a percentage of the premium of the individual member, i.e., how much of the members premium went toward paying claims that occurred in both the network and the group.

Each line graph corresponds to a group having a given loss ratio (“loss ratio” for a group=total claims in a group/total premiums in the group), i.e., a loss ratio internally of 0%, 10%, 20%, 30%, 40%, 50%, 60%, 70%, 80%, 90% or 100%. The loss ratio of the network as a whole is where the lines converge, e.g., 50% in this case. Other values than 50% may be used, which would be determined by premiums divided by claims for the entire network. The 50% is used just for illustration purposes. In general, the “Loss Ratio” refers to the total claims in the group divided by total premium in the group. In particular, each of the dots making-up a line represents an individual member who is part of a group where the loss ratio is that of that line, their particular group may be large or small and that is what determines their independence factor on the X axis.

As a group becomes more independent, an individual member is more affected by the claims of their own group rather than the claims of the network at large. This can be seen since the proportion of premium that a member pays in claims (i.e., the loss ratio) is more in-line with the loss ratio of the group they are a part of, the more independent that group is.

For example, if someone is a member of a group that is 90% independent and has a loss ratio of 20%, shown by arrow 352, the amount of claims allocations which the member receives as part of that group will be about 20% of their premium (i.e., 20% of their premium paid is used to pay claims and 80% remains), which is the same as the group's whole loss ratio of 20%. Whereas, for a member who is part of a group with a claims ratio of 20% but with a very low independence of 5%, shown by arrow 354, they will get allocated very close to 50% of their premium in claims which is more in-line with the overall network loss ratio of 50%.

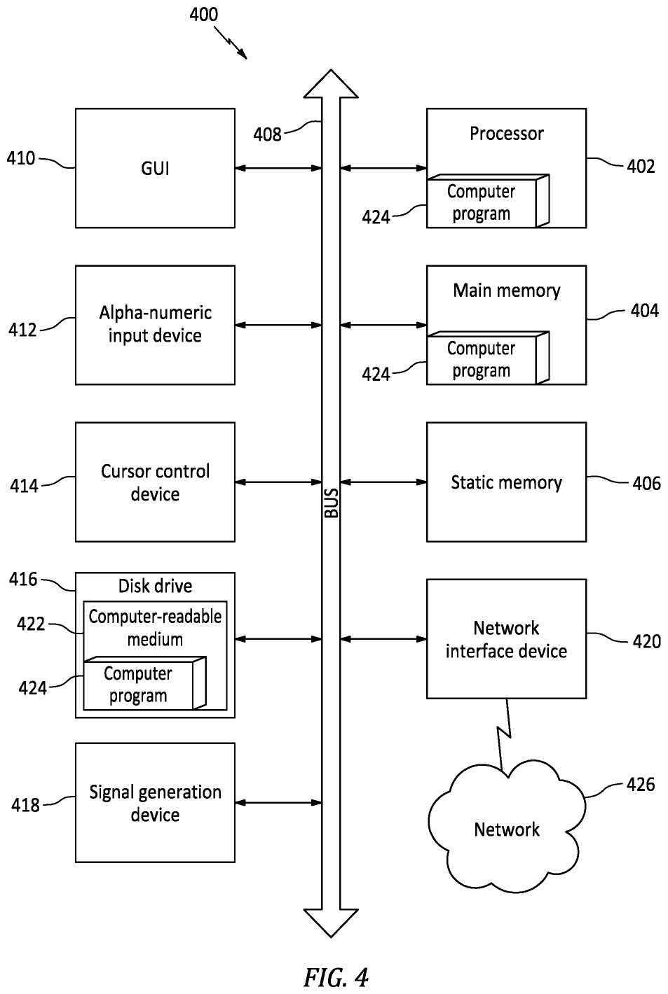

FIG. 4 shows a diagrammatic representation of a computer 400 within which a set of instructions, for causing the computer 400 to perform any one or more of the methodologies described herein, may be executed. In a networked deployment, the computer 400 may operate in the capacity of a server or a client machine in server-client network environment, or as a peer machine in a peer-to-peer (or distributed) network environment. The computer 400 may be a personal computer (PC), a tablet PC, a set-top box (STB), a personal digital assistant (PDA), a cellular telephone, a web appliance, a network router, switch or bridge, or any computer 400 capable of executing a set of instructions (sequential or otherwise) that specify actions to be taken by that computer 400. Further, while only a single computer 400 is illustrated, the term “computer” shall also be taken to include any collection of computers, or a decentralized network of “computers”, that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both, a main memory 404 and a static memory 406, which communicate with each other via a bus 408. The computer 400 may further include a video display unit 410 (e.g., a liquid crystal display (LCD)). The computer 400 also includes an alphanumeric input device 412 (e.g., a keyboard), a cursor or touch control device 414 (e.g., a mouse, touchscreen), a disk drive unit 416, a signal generation device 418 (e.g., a speaker) and a network interface device 420.

The disk drive unit 416 includes a computer-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting computer-readable media.

The software 424 may further be transmitted or received over a network 426 via the network interface device 420 utilizing any one of a number of well-known transfer protocols (e.g., HTTP, FTP).

While the computer-readable medium 422 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer 400 and that cause the computer 400 to perform any one or more of the methodologies of the present embodiments, or that is capable of storing, encoding or carrying data structures utilized by or associated with such a set of instructions. The term “computer-readable medium” shall accordingly be taken to include, but not be limited to, solid-state memories and optical and magnetic media. The server 110 as described herein may include at least some of the components of the computer 400.

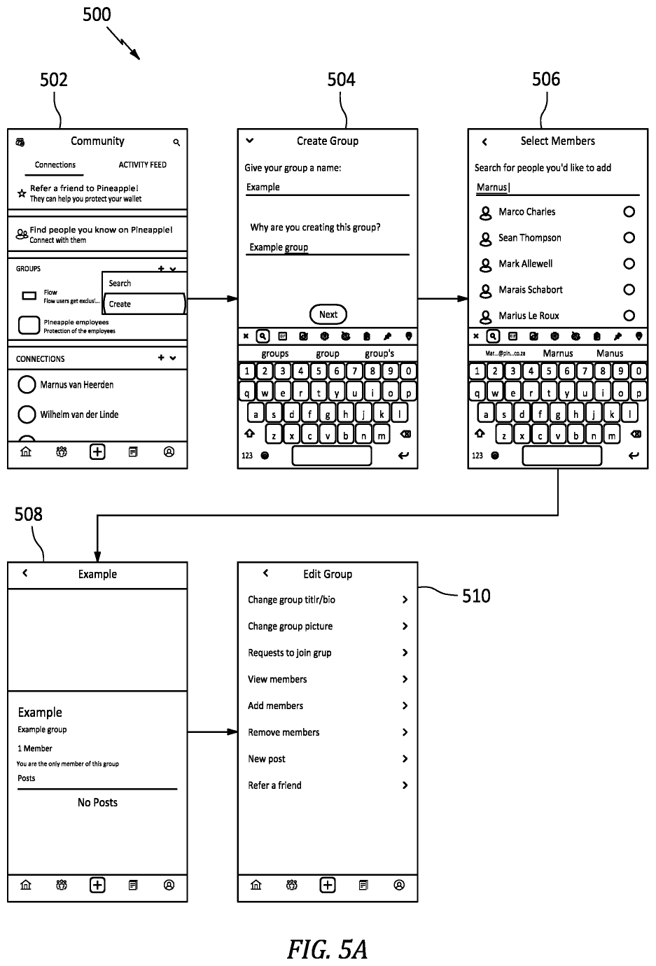

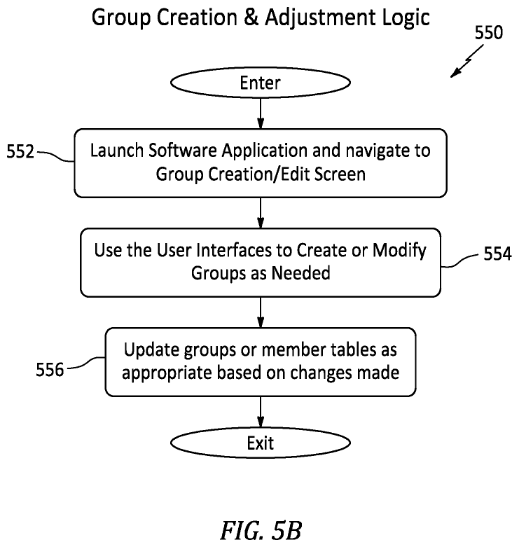

Referring to FIG. 5A, several screen illustrations (or screen shots) 502, 504, 506, 508, 510 of a user interface of a software application on a mobile device are shown, illustrating how a group may be established and modified, according to embodiments of the present disclosure, as discussed hereinbefore with FIG. 2 (block 202). In particular, the UI in screen shot 502 allows the user or member to view the groups that currently exist in the network and to search for a group or create a group. Next, if the user is creating a group, the UI in screen shot 504 allows the user or member to name the groups and explain its purpose. Next, the user can select people that the user wants in the new group, as shown in the UI in screen shot 506. After the members are selected, the user is allowed to save the group. Once created the screen shot 508 shows the group name and purpose on the new group screen, called “Example” in this case. Once a group is created, it may be edited or modified, as shown in the UI in screen shot 510. For example, the user may: change group title/bio/purpose, change group picture, request to join a group, view members of a group, add members to a group, remove members from a group, create a new post associated with a group (which may be viewed and responded to by members of that group), and refer a friend (or contact) to a group. Other functions may also be performed, if desired.

Referring to FIG. 5B, a flow diagram 500 illustrates one embodiment of a process or logic of stage (or block) 202 (FIG. 2) for implementing the Group Establishing Module or Logic 112 and/or the Storing Module 118 (FIG. 1), as also illustrated in screen shots in FIG. 5A, which may be referred to herein as the Group Creation and Adjustment Logic. In particular, the process 550 begins at block 552 and performs blocks or steps 552-556, as shown in the flow diagram 5500 of FIG. 5B, to allow groups to be created and adjusted or modified.

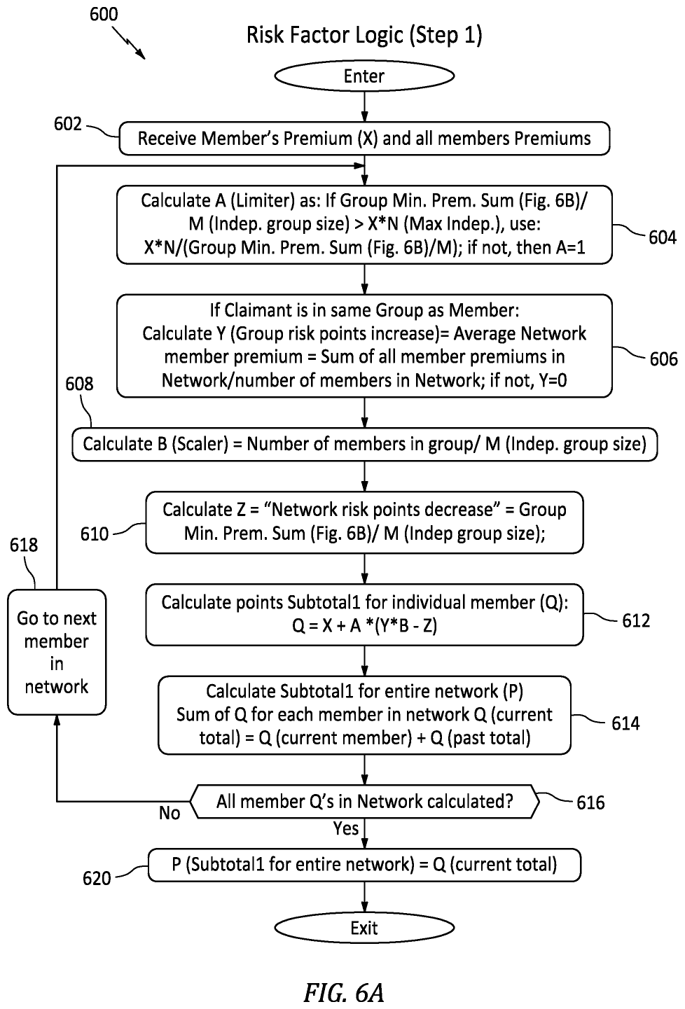

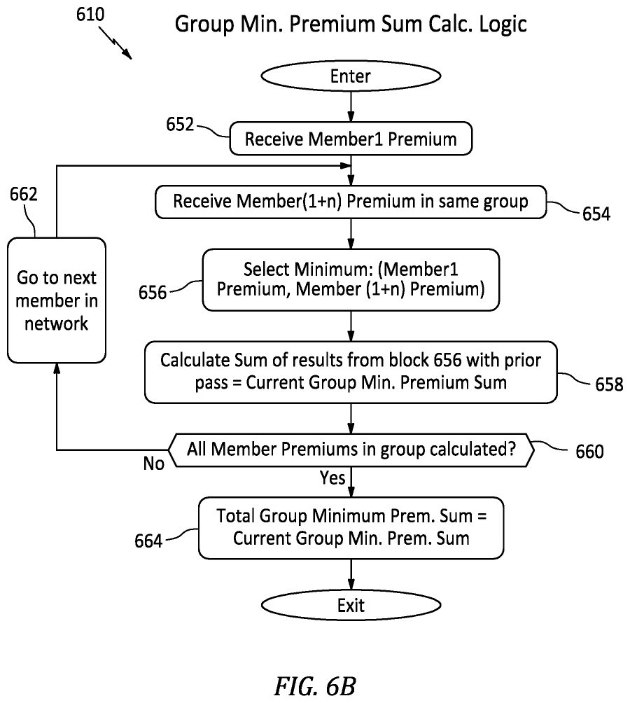

Referring to FIGS. 6A, 6B, 7 and 8, in general, in some embodiments, member Risk Weighting Factor Calculations are based on member premium, number of connections of member, the connection's premium, and some adjustment factors to ensure fairness. In particular, the various risk calculations and claim liability calculations described herein for members based on the member status, group status, and the network as a whole, may use the parameters defined below. It should be understood that the calculations provided herein are one example of the method and system of the present invention, provided for illustrative purposes. Other parameters and equations for the risk calculations may be used if desired provided it provides the overall function and performance described herein.

### Parameter Definitions

X=Premium=Proxy for the risk an individual member adds to a group.
Y=Group Risk Factor Points Increase (or “Penalty” Points)=Proxy for the risk an individual member absorbs (or incurs) for being in the same group as a claimant, only if the claimant is in the same group as the member who's risk calculation is being determined. When member is in same group as claimant, Y=Avg. Member Network Premium. If member being risk-assessed is Not in the group with the claimant, then Y=0 for that member. This may be computed as an adjustment increase to a member's general risk weighting (and may also be referred to herein as group risk factor adjustment or adjustment factor).
Z=Network Risk Factor Points Decrease (or “Advantage” Points)=Proxy for the “advantage” of being in the same group as members who have not claimed. This may be computed as an adjustment decrease to a member's general risk weighting (and may also be referred to herein as network risk factor adjustment or adjustment factor).
A=A “Limiter” that prevents a member from gaining more advantage points than the member's own premium, hence resulting in negative allocations.
B=A “Scaler” that allows Penalty Points to increase (or scale) as the larger network grows. Thus, it either increases or decreases the impact of Penalty Points on an individual member based on the size of the network as a whole.
C=A final premium “Adjuster” ensures that premium remains relevant in the equation and is not discounted as a risk factor.
M=The group “size” (or “volume”) needed to qualify to be independent, which allows members of that group to be independent (up to a maximum independence level, as discussed herein). In some embodiments, as described herein, the “size” of a group is related to the number of members in the group and the sum of the premiums of a member's group members and the member's own premium (i.e., a multiple of a member's own premium). Thus, a member needs to connect to other members to have a chance of being independent or unaffected by the claims of those outside the member's connections. M is determined by an administrator of the system or may be pre-set to a default value, e.g., M=150, based on the value of Dunbar's constant (the average number of people an individual can maintain a stable social relationship with).
N=The maximum independence level a group (or members thereof) can achieve (value range: 0 to 1.0). For example, if N=0.9 for a group, the members of the group can only achieve 90% independence from the network and will always be affected by 10% of the larger network community.
Q=Subtotal 1 for an individual member.
P=Subtotal 1 for the entire network.
R=Subtotal 2 for an individual member.
S=Subtotal 2 for the entire network.

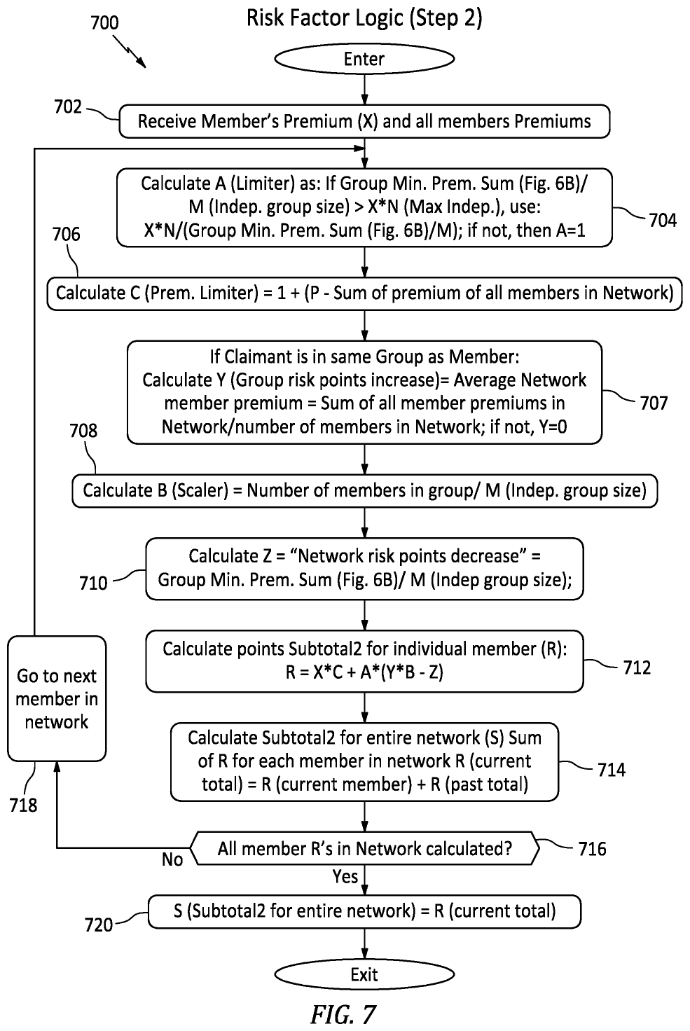

Referring to FIG. 6A, a flow diagram 600 illustrates one embodiment of a process or logic of stage (or block) 204 (FIG. 2) of the Risk Factor Module 116 (FIG. 1) for calculating and adjusting the general risk weighting of each member added to the group, which may be referred to herein as Risk Factor Logic—Step1. In particular, the process 600 begins at block 602 and performs blocks or steps 602-620, as shown in the flow diagram 600 of FIG. 6, to calculate the risk parameters discussed herein. The result of Risk Factor Logic—Step 1 shown by flow diagram 600 provides values for parameters Q (Subtotal 1 for individual member) and P (Subtotal 1 for entire network) used by the flow diagram of FIG. 7, described hereinafter.

Referring to FIG. 6B, a flow diagram illustrates one embodiment of a process or logic of stage (or block) 610 of FIG. 6A, Risk Factor Logic—Step1, which may be referred to herein as Group Minimum Premium Sum Calculation Logic. In particular, the process 610 begins at block 652 and performs blocks or steps 652-664, as shown in the flow diagram 610 of FIG. 6B, to calculate the risk parameters discussed herein. This group minimum premium sum calculation logic 610 helps avoid having a large premium (large risk) in a group determine, or disproportionately influence, the independence determination of a given group.

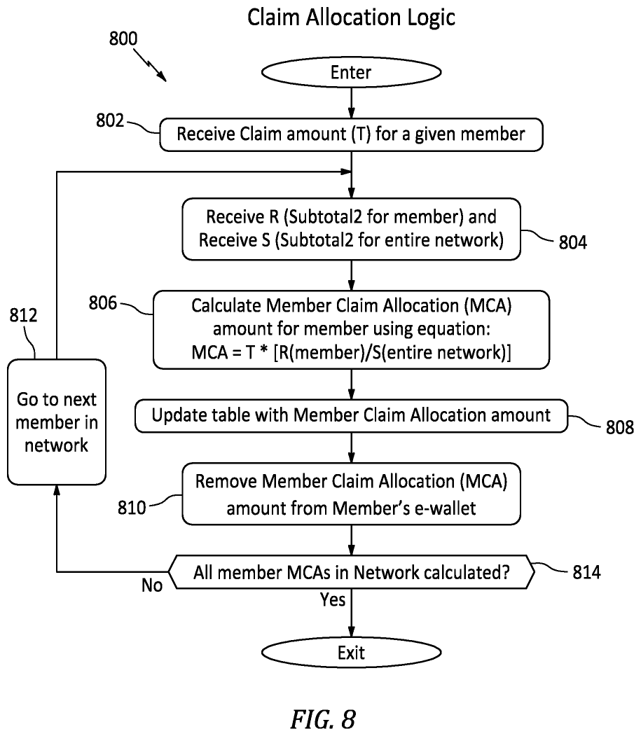

Referring to FIG. 7, a flow diagram 700 illustrates one embodiment of a portion of the process or logic of stage (or block) 204 (FIG. 2) of the Risk Factor Module 116 (FIG. 1) for further calculating and adjusting the general risk weighting of each member added to the group, which may be referred to herein as Risk Factor Logic—Step2. In particular, the process 700 begins at block 702 and performs blocks or steps 702-720, as shown in the flow diagram 700, to calculate the risk parameters discussed herein. The result of Risk Factor Logic—Step 2 shown by flow diagram 700 provides values for parameters S (Subtotal 2 for individual member) and R (Subtotal 2 for entire network) used by the Claim Allocation Logic 800 of FIG. 8, described hereinafter.

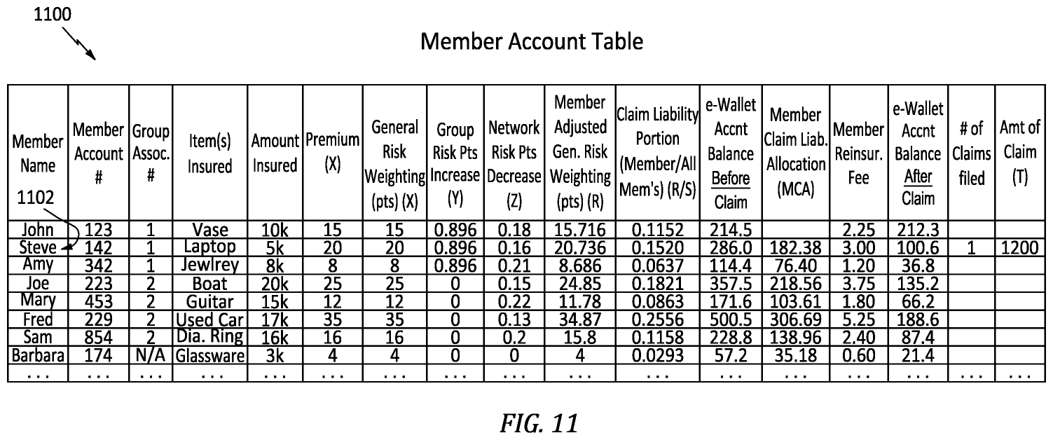

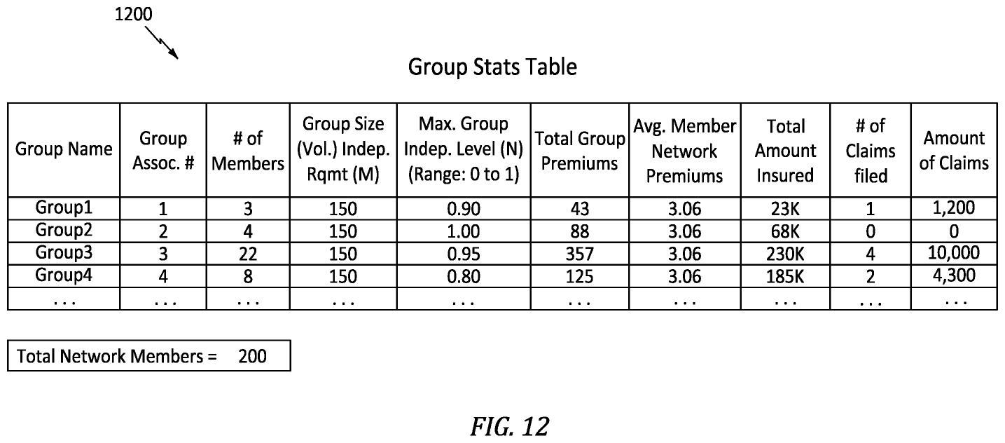

Referring to FIG. 8, a flow diagram 800 illustrates one embodiment of a process or logic of stage (or block) 206 (FIG. 2) of the Group Administration Module 114 (FIG. 1) which determines how liable members of the group are for claims originating inside and outside the group, which may be referred to herein as Claim Allocation Logic. The process 800 begins at block 802 and performs blocks or steps 802-814, as shown in the flow diagram 800, to calculate the risk and claim allocation parameters discussed herein. The result of the Claim Allocation Logic 800 provides values the member claim allocation (MCA) or portion of a claim amount to be paid by a given member. The Claim Allocation Logic 800 also handles the claim amount reduction from each members e-wallet account resulting from a given claim made each members liability associated therewith. Also, see Tables 1100, 1200 (FIGS. 11 and 12) herein for more information regarding member claim allocation. In some embodiments, an alert may be provided to the member or user when a claim is paid out from a member's account, and indicate the current point balance for the member, and the details of the claim(s) paid.

Examples for the flow diagrams of FIGS. 6A, 6B, 7 and 8 are shown below. In particular, an example for Step 1, FIGS. 6A and 6B, is shown below.

John has a premium of $30. John is in a group with Steve ($10 premium) and Amy ($50 premium), thus, 3 people (or members) in group. First, allocate 30 points to John as X (premium), thus, X=30 pts. Assume M (Indep. Group size)=150 (preset value) and N (Max. Indep. Level)=0.9. Then, calculate A (Limiter), by taking the sum of the smallest of 30 and 10, and of 30 and 50=10+30=40=A (See FIG. 6B—Group Min. Premium Sum Calc.). Then, take 40 and divide by 150=0.26. Since 0.26 is not larger than member's premium*90% (maximum independence level parameter), set A=1.

Next, calculate Y (group risk points increase or “penalty” points). Use the total premium in the entire network divided by the total number of people in the network. Assume 200 total members with $4,000 total premium equals $20 average premium, thus Y=20). Then, calculate B (“Scaler”)=the number of policyholders (members) in the network 200 divided by M (150)=1.333=B. Then, calculate Z (network risk points decrease).

Then, take the sum of the minimum of 10 and 30, and of 30 and 50 (same as above), giving: 10+30=40 (See FIG. 6B—Group Min. Premium Sum Calc.). Then, take 40/150=0.267=Z (network risk points decrease or “advantage” points).

Now, assume that Amy is the claimant. For John's points we use:

Q=X+A*(Y*B−Z)=30+1*(20*1.333−0.267)=56.40 Eq. 1

This gives John a total points or Q=56.40 (the total adjusted general risk weighting for the member John). Then, calculate the aggregate sum Q for each member in the network to get to an amount for P (for use in Step 2). In this case, we will assume P=8,000 (for illustrative purposes), for use in Step 2, shown below.

In particular, an example for Step 2 (FIGS. 7 and 6B) and Claim Allocation (FIG. 8) is shown below. Again, John has a premium of $30, and is in a group with Steve ($10) and Amy ($50 premium), and Amy submits a claim.

First, allocate 30 points to John as X, so X=30 (for premium). Again, assume M (Indep. Grp size)=150. Next, calculate C (Prem. Adjuster)=1+(P−sum of premium of all members in the network)/sum of premium of all members in the network=1+(8000−4000)/4000. Assume P=8,000 (from prior Step 1), for the sake of this example. Thus, in this case, C=2.

Next, calculate A (Limiter). Sum of the smallest of (30 and 10) and (30 and 50)=10+30=40 (See FIG. 6B—Group Min. Premium Sum Calc.). Then we take 40 and divide by 150=0.26=A. Since 0.26 is not larger than the member (John's) premium*90%, set A=1.

Next, calculate Y (group risk points increase or penalty points). Use the total premium in the entire network divided by the total number of people in the network. Assume 200 members in the network with $4,000 total premium equals $20 average premium in the network. Since Amy is in the same group as John, we use the average premium (of network) for the value of Y. If Amy was not in the same group as John, Y (John's group risk points increase) would be 0, i.e., Y=0 in that case.

Next, calculate B (“Scaler”) as the number of policyholders (members) in network, 200, divided by 150 (M)=1.333=B. Next, calculate Z (Network risk points decrease). We take the sum of the minimum of (10 and 30) and of (30 and 50) again, giving us 10+30=40. Then, we take 40/150=0.267=Z (network risk points decrease or “advantage” points).

Amy is the claimant. For John's claim liability of a claim from Amy we use:

R=X*C+A*(Y*B−Z)=30*2+1*(20*1.333−0.267)=86.39 Eq. 2

If we calculate the sum R for all members we will get to an amount S, and the resulting proportion of Amy's claim paid by John is represented as R/S.

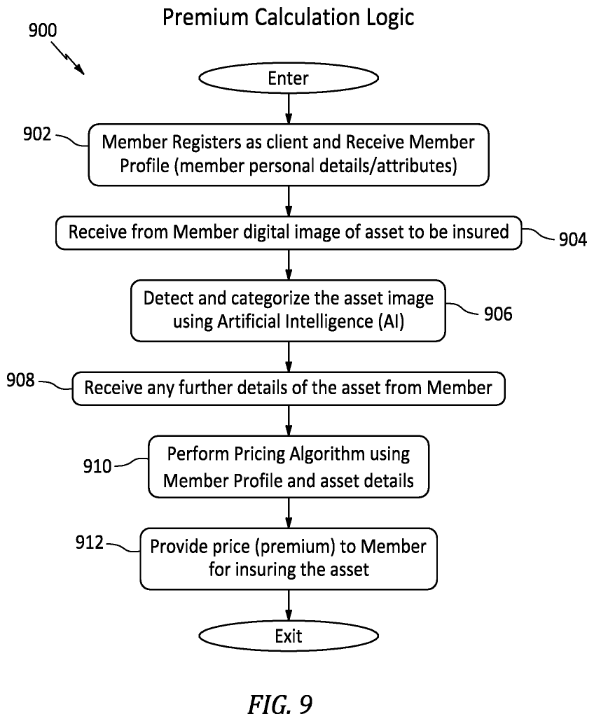

Referring to FIG. 9, a flow diagram 900 illustrates one embodiment of a process or logic of a Premium Calculation Logic (which may be implemented as part of the Risk Factor Module or Group Admin. Module or other module herein or may be a separate module), which calculates the premiums of members based on the member's profile (including member's claim history) and the asset to be insured. The process 900 begins at block 902 and performs blocks or steps 902-912, as shown in the flow diagram 900, to calculate the premium (X) described herein.

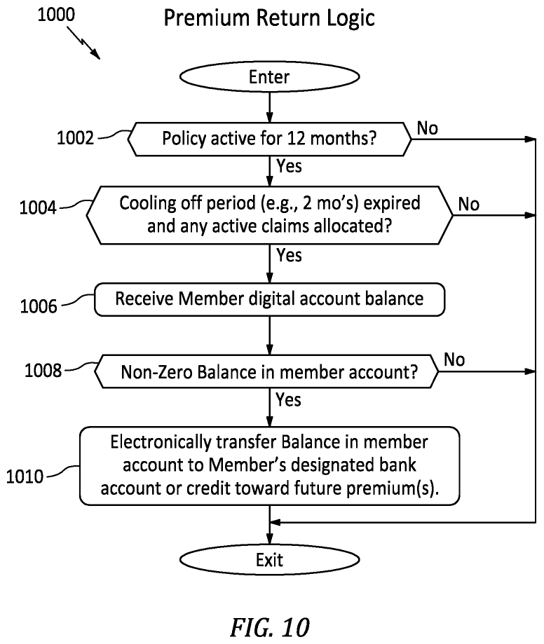

Referring to FIG. 10, a flow diagram 1000 illustrates one embodiment of a process or logic of a Premium Return Logic (which may be implemented as part of the Risk Factor Module or Group Admin. Module or other module herein or may be a separate module), which calculates the premiums of members based on the member's profile (including member's claim history) and the asset to be insured. The process 1000 begins at block 1002 and performs blocks or steps 1002-1010, as shown in the flow diagram 1000, to determine how much, if any, premium gets returned to the member. In particular, if a member has a non-zero account balance left-over at the end of an insurance term or period (e.g., 12 months), and after a “cooling off” period to allow any claims to be allocated to the member, that account balance money is automatically electronically returned to the member and deposited (or e-transferred) into a bank account designated by the member, and an alert (text or email or the like) may be provided to the member indicating the return has occurred and/or the amount returned. In some embodiments, the member may choose to have all or a portion of the remaining account balance be credited toward the next term's premium. When a new insurance period begins, the member would pay a new premium amount for the assets insured (minus any credits from prior terms, if applicable), which premium may be placed in a new (or fresh) e-wallet account for the member at the beginning of the new insurance period.

Referring to FIG. 11, a sample Member Account Table 1100 is shown, including columns for Member Name, Member Account #, Group Associated #, Item(s) Insured, Amount Insured, Premium, General Risk Weighting (in points), Group Risk Factor Points Increase, Network Risk Points Factor Decrease, Total Adjusted General Risk Weighting (in points), Claim Liability points (adjusted member general risk weighting/all members adjusted general risk weighting), e-Wallet Account Balance Before a Claim, Claim Liability (for this member), Reinsurance fee, e-Wallet Account Balance Before the Claim, # of Claims filed, Total Dollar Amount of Claims by member. The table 1100 show sample amounts relating to each members liability from a single member claimant, shown as the second Row 1102, for Member Steve (shaded row). The table 1100 shows example values and calculations and specifically the claim liability or allocation regarding a particular claim which is getting distributed (i.e., for row 1102 to member Steve who is the Claimant in this example).

In particular, member Steve's has a premium of $20, which corresponds to 20 points under Premium column, which is also equivalent to Steve's general risk weighting points or GRW (or X), which is 20 points. The group risk points increase (or Y) is 0.896, the network risk points decrease (or Z) is 0.16; and thus the total adjusted general risk weighting points is 20.736 (20+0.896−0.16=20.736), assuming A=1 B=1, C=1 for this example. The Member Claim Liability Portion (or allocation or ratio) for Steve in this case is 0.1520 (Member Adjusted Gen. Risk Weighting/Total of All Members Adjusted Gen. Risk Weightings=R/S). Thus, Steve's Claim Liability will be 182.38 (Claim Amount*Claim Liability portion=1,200*0.152=182.38). Also, Steve's reinsurance fee in this case is 3.00 (e.g., Steve's Premium*15% Reinsurance fee=20*0.15=3.00). Accordingly, Steve's e-Wallet balance after the claim would be 100.6 (e-Wallet balance before claim—Steve's claim liability—Reinsurance fee=286.0−182.38-3.00=100.6). The other parameters in the calculations (e.g., A (Limiter), B (Scaler), and C (Adjuster)) may also be stored in the Tables 1100,1200, which may also be stored on the server. Other reinsurance fees or percentages may be used if desired.

Also, note that a single member that does not join a group, e.g., Barbara in the Table 1100, may be placed in a single-member group, for the purposes of assessing claim liability of each member in the network (including the non-group members).

Similarly, the portion of Steve's $1,200 claim paid by John would be 138.23 (0.1152*1,200=138.23, rounded per table), and the portion of Steve's $1,200 claim paid by Amy would be $76.44 (0.0637*1,200=76.40, rounded per table), all of which are in the same group as Steve. Also, the portion of Steve's $1,200 claim paid by Joe, Mary, Fred, Sam, and Barbara, who are not in the same group as Steve, would be $218.56, $103.61, $306.69. $138.96, $35.18, respectively, based on the calculations described herein.

The values shown herein are for exemplary purposes and may be rounded up or down, to the nearest integer or tenth, or hundredth, or truncated, as desired.

As information and parameters are updated based on member activity, the system of the present disclosure updates this table accordingly, which may be stored on the server.

Referring to FIG. 12, a sample Group Statistics Table 1200 is shown, providing data or statistics associated with each group in the network, including columns for Group Name, Group # or code, Number of members in group, Group Size (or volume) Independence Requirement (M), which may be the same of different for each group, Maximum Group Independence level (or N), which may be the same of different for each group, with values 0 to 1, Total Group Premiums, Average Member Network Premiums (total network premiums/total number of network members), Total Amount Insured, # of claims filed by the group, Total Dollar Amount of Claims filed by the group. The table 1200 (or database) may also include a field for the total network members, e.g., 200 in this example. As information and parameters is updated based on member activity, the system of the present disclosure updates this table accordingly, which may be stored on the server.

The Inventors believe that embodiments of the invention may provide numerous features and advantages.

The system described herein may be used by members to establish cell captives in a digital manner. The rules governing a captive, including reinsurance, may scale automatically and in real-time as the group grows without any manual intervention or administration. This allows ordinary members of the public to gain access to a useful type of insurance, without requiring significant knowledge (e.g., regulatory knowledge or administrative skills) or capital. The system of the present disclosure allows for a wide range of risk to be part of the network and does not require the risk type or quantum to be similar in order to function. For example, it allows for members who have insured high premium items, e.g., expensive cars and boats and the like, with other members who insure other types of items (lower priced), e.g., a laptop, vase, a dog, guitar, jewelry, glassware, or any other personal property item, all in the same group if desired.

Embodiments of the invention may provide a flexible system, making provision for diverse risk types, premiums and group sizes, which may ensure that cell captives are more readily adopted and utilized. A group can be scaled up, from being part of the “mutual”/community or network as a whole to being completely isolated. The risk and independence level of a group are shifted gradually and only to the extent that the group is actually capable of absorbing risk, i.e., covering liability that may arise. This may be carried out by the system as described herein without the need for manual decision-making on a case-by-case basis, and in real-time as member risk situations change. The present disclosure provides a continuous dynamic group membership environment.

Members may easily create and join groups, e.g., using a mobile software application, and once a member joins he or she is automatically connected to all other members of the group. The group protects them, partially or completely, from the claims of those outside the group. Embodiments of the invention allow time for a group or members thereof to function more and more as a cell captive until the group is large enough (or has enough resources) to be completely self-sustaining. This essentially permits the formation and management of a “consumer-created” cell captive. Also, in the present disclosure, instead of pooling premiums, it automatically allocates claim liability and automatically electronically deducts a claim allocation from each member's e-wallet account when a claim occurs. It also allows each member to see in real-time the status of their account at any time and how it is affected by any other members in the group or entire network.

Furthermore, when calculating risk factors, instead of considering the network/group as a whole, the risk of each individual member relative to the risk of the other members in the group and network as a whole may be considered. Calculation of risk factors, group independence levels, claim allocations and reinsurance may be carried out without user intervention.

Some embodiments of the present disclosure may include one or more of the following systems or methods.

According to one aspect of the invention, there is provided a computer-implemented method of managing a digital group in a digital peer-to-peer insurance network, the digital network including a plurality of members each having a member account, wherein the method comprises: establishing, e.g., by a group establishing module or other module or logic, a digital group which is configured to include a subset of the members of the digital network; adding, e.g., by a group administration module or other module or logic, a member of the network to the group by associating the member account of the member with the group; determining, e.g., by a risk factor module or other module or logic, for the member account of the member added to the group, a group risk factor and a network risk factor, these factors are used to determine liability of the new group member account in the event of a claim originating from a member account which forms part of the same group (in-group claimant), and determine the liability of the new member account in the event of a claim originating from a member account which does not form part of the same group (non-group claimant); in some embodiments, the group risk factor may be used to determine liability of the member account in the event of a claim originating from a member account which forms part of the group, and wherein the network risk factor is used to determine liability of the member account in the event of a claim originating from a member account which does not form part of the group; and adjusting, by the risk factor module, the group risk factor and/or the network risk factor of the member of the group in response to another member being added to or leaving the group or network, or in response to a change in risk associated with a member account in the group.

The method may include determining a “group risk factor” and/or a “network risk factor” for the member account of each member of the group. The method may include, in response to a new member being added to the group, determining a group risk factor and/or a network risk factor for the member account of the new member and adjusting the group risk factor and/or network risk factor of the member account of each other member of the group. In response to a member leaving the group, the group risk factor and/or network risk factor of the member account of each of the remaining members of the group may be adjusted. Likewise, group and network risk factors may be adjusted in response to risk being added or reduced by a member of the group (i.e. in response to a change in risk associated with a member account).

The group risk factor may be determined by aggregating with weightings a general risk weighting of the member account of a member with the “general risk weighting” of one or more of the member accounts of members who are part of the group. An “additional risk weighting” may be added to the general risk weighting to arrive at the group risk factor.

The additional risk weighting may be determined based on risk weightings of one or more other member accounts of the group, e.g., based on relative risk weightings in the group.

The network risk factor may be determined by aggregating with weightings the general risk weightings of all member accounts in the network and deducting the group risk factor from this aggregation.

In some embodiments, a “risk weighting deduction” may be applied to arrive at the network risk factor and the “additional risk weighting” referred to above may, in some embodiments, be substantially equal but opposite to the “risk weighting deduction”.

The member accounts may be digital electronic wallets (or e-wallets) used in the digital peer-to-peer insurance network. The “general risk weighting” for a particular member account may be a risk weighting based on one or more factors, such as a premium paid into the wallet and/or an item insured, and/or a sum insured (level of coverage for the item insured) and/or any other measure of risk.

The adjusting step may include, for each new member added to the group or each additional risk added by existing members of the group, allocating a “risk weighting deduction” to the network risk factors of the members of the group and adding an “additional risk weighting” to the group risk factors of the members of the group.

The method may include determining, an independence level of the group. The independence level may be determined based on a level of exposure of members of the group to claims originating from member accounts outside of the group. In some embodiments, the independence level of the group may be adjusted in a linear fashion from 0 or close to 0 to a maximum at which the group is designated a full cell captive.

The method may include linearly increasing the group risk factor of a member's account and linearly decreasing the network risk factor of a member's account, by the risk factor module, as more member accounts are added to the group or additional risk is added by existing member accounts of the group. In this way, the independence level of the group may be adjusted linearly and when maximized, the group may form a cell captive.

In some embodiments, therefore, once the group has sufficient members, the network risk factors of the member accounts of the group may be zero, indicating that the group is self-sustaining and able to function as a cell captive within the network. The independence level may then be designated as having reached the maximum, e.g., a level of 100/100%.

The method may include identifying and/or measuring, by the group administration module and/or the risk factor module, that the independence level of the group has reached the maximum, or cell captive state.

Until the maximum independence level is reached, as the group grows in size, there may be a gradual, e.g., linear, transfer towards it where the member of the group is partially exposed to a general community of the network and partially exposed to group.

The method may include determining, e.g., by a group administration module and/or a risk factor module or other module/logic, a level of liability of each member of the group for a claim originating from a member account which does form part of the group and originating from a member account which does not form part of the group, respectively, based on the independence level of the group, and in the event of a claim originating from a member account which does form part of the group, the group administration module and/or the risk factor module may increase the liability of the member of the group for this claim as the independence level of the group grows, and in the event of a claim originating from a member account which does not form part of the group, the group administration module and/or the risk factor module may decrease the liability of the member of the group for this claim as the independence level of the group grows.

The method may include storing the member accounts of the members of the group in association with each other in the database.

The functionality of one or more of the modules or logic described herein, e.g., the group establishing module, the group administration module and/or the adjusting module, including the logics described in FIGS. 6A-9 herein, may be provided by a server, e.g., a remotely accessible server. The server may include a server computer or a cluster of computers, or any suitable computer system or systems, which may be in the same or different locations.

Communications between members of the network and the server may be carried out via a web-based platform or other communication network. The platform may be provided by a mobile software application, website, or the like. Communications may also be carried out using native mobile software.

According to another aspect of the invention, there is provided a system for managing a digital group in a digital peer-to-peer insurance network, the digital network including a plurality of members each having a digital member account, wherein the system includes a server which comprises: a group establishing module for establishing a group which is configured to include a subset of the members of the network; a group administration module for adding a member of the network to the group by associating the member account of the member with the group; and a risk factor module for determining, for the member account of the member added to the group, a group risk factor and a network risk factor, wherein the group risk factor is used to determine liability of the member account in the event of a claim originating from a member account which forms part of the group, and wherein the network risk factor is used to determine liability of the member account in the event of a claim originating from a member account which does not form part of the group, wherein the risk factor module is configured to adjust the group risk factor and/or the network risk factor of the member of the group in response to another member being added to or leaving the group or network, or in response to a change in risk associated with a member account in the group.

The server may include a storing module for storing data relating to the member accounts in a database. The system may include or be communicatively coupled to the database.

According to a further aspect of the invention, there is provided a computer program product including at least one computer-readable medium having stored thereon at least one computer program which, when executed by a computer or a computerized system, causes the computer or computerized system to perform a method of managing a group in a peer-to-peer insurance network, substantially as described above. The computer-readable medium may be a non-transitory computer-readable medium.

The system, computers, servers, devices and the like described herein have the necessary electronics, computer processing power, interfaces, memory, hardware, software, firmware, logic/state machines, databases, microprocessors, communication links, displays or other visual or audio user interfaces, printing devices, and any other input/output interfaces, to provide the functions or achieve the results described herein. Except as otherwise explicitly or implicitly indicated herein, process or method steps described herein may be implemented within software modules (or computer programs) executed on one or more general purpose computers. Specially designed hardware may alternatively be used to perform certain operations. Accordingly, any of the methods described herein may be performed by hardware, software, or any combination of these approaches. In addition, a computer-readable storage medium may store thereon instructions that when executed by a machine (such as a computer) result in performance according to any of the embodiments described herein.

In addition, computers or computer-based devices described herein may include any number of computing devices capable of performing the functions described herein, including but not limited to: tablets, laptop computers, desktop computers, smartphones, smart TVs, set-top boxes, e-readers/players, and the like.

Although the disclosure has been described herein using exemplary techniques, algorithms, or processes for implementing the present disclosure, it should be understood by those skilled in the art that other techniques, algorithms and processes or other combinations and sequences of the techniques, algorithms and processes described herein may be used or performed that achieve the same function(s) and result(s) described herein and which are included within the scope of the present disclosure.

Any process descriptions, steps, or blocks in process or logic flow diagrams provided herein indicate one potential implementation, do not imply a fixed order, and alternate implementations are included within the scope of the preferred embodiments of the systems and methods described herein in which functions or steps may be deleted or performed out of order from that shown or discussed, including substantially concurrently or in reverse order, depending on the functionality involved, as would be understood by those reasonably skilled in the art.

It should be understood that, unless otherwise explicitly or implicitly indicated herein, any of the features, characteristics, alternatives or modifications described regarding a particular embodiment herein may also be applied, used, or incorporated with any other embodiment described herein. Also, the drawings herein are not drawn to scale, unless indicated otherwise.

Conditional language, such as, among others, “can,” “could,” “might,” or “may,” unless specifically stated otherwise, or otherwise understood within the context as used, is generally intended to convey that certain embodiments could include, but do not require, certain features, elements, or steps. Thus, such conditional language is not generally intended to imply that features, elements, or steps are in any way required for one or more embodiments or that one or more embodiments necessarily include logic for deciding, with or without user input or prompting, whether these features, elements, or steps are included or are to be performed in any particular embodiment.

Although the invention has been described and illustrated with respect to exemplary embodiments thereof, the foregoing and various other additions and omissions may be made therein and thereto without departing from the spirit and scope of the present disclosure.

What is claimed is:

1. A computer-implemented method of managing a group in a digital peer-to-peer insurance network, the digital peer-to-peer network including a plurality of members each having an electronic member account, comprising:
establishing a group comprising a subset of the members of the network;
adding a member of the network to the group (new group member) by associating the member account of the new group member (new group member account) with the group;
determining, for the new group member account, a group risk factor and a network risk factor, wherein these factors are used to determine liability of the new group member account in the event of a claim originating from a member account which forms part of the same group (in-group claimant), and determine the liability of the new member account in the event of a claim originating from a member account which does not form part of the same group (non-group claimant); and
adjusting the group risk factor and the network risk factor of the new group member in response to another member being added to or leaving the group or network, or in response to a change in risk associated with a member account in the group.

2. The method of claim 1 wherein the determining comprises determining the group risk factor and the network risk factor for the member account of each member of the group.

3. The method of claim 1 further comprising, in response to a new member being added to the group, determining a group risk factor or a network risk factor for the member account of the new member and adjusting the group risk factor or network risk factor of the member account of each other member of the group.

4. The method of claim 1, further comprising, in response to a member leaving the group, the group risk factor and/or network risk factor of the member account of each of the remaining members of the group may be adjusted.

5. The method of claim 1, further comprising, adjusting the group and network risk factors in response to risk being added or reduced by a member of the group (i.e. in response to a change in risk associated with a member account).

6. The method of claim 1, wherein the group risk factor, for each member of the group, is determined by aggregating with weightings a general risk weighting of the member account of a member with the general risk weighting of one or more of the other member accounts of the other members who are part of the group.

7. The method of claim 1, wherein the group risk factor comprises an additional risk weighting added to the general risk weighting to arrive at the group risk factor.

8. The method of claim 7, wherein the additional risk weighting is determined based on risk weightings of one or more other member accounts of the group.

9. The method of claim 1, wherein the network risk factor is determined by aggregating with weightings the general risk weightings of all member accounts in the network as a network aggregation and deducting the group risk factor from the network aggregation.

10. The method of claim 7, wherein the network risk factor comprises a risk weighting deduction and the additional risk weighting is substantially equal but opposite to the risk weighting deduction.

11. (canceled)

12. The method of claim 1, wherein the general risk weighting for a particular member account is a risk weighting based on one or more factors comprising at least one of: a premium paid into the wallet, a sum (or amount) insured, and a general measure of risk.

13. The method of claim 1, wherein the adjusting step comprises, for each new member added to the group or each additional risk added by existing members of the group, allocating a risk weighting deduction to the network risk factors of the members of the group and adding an additional risk weighting to the group risk factors of the members of the group.

14. The method of claim 1, further comprising determining a group independence level of the group based on a level of exposure of group members to non-group claims.

15. The method of claim 14, wherein the group independence level is adjusted in a linear fashion from about 0 to a maximum independence level at which the group is designated a full cell captive.

16. (canceled)

17. (canceled)

18. The method of claim 15, further comprising identifying that the group independence level has reached the maximum independence level and designating the group as in a cell captive state.

19. (canceled)

20. The method of claim 1, further comprising, determining an in-group claim liability level for each member of the group for a claim originating from a member account which forms part of the group based on the independence of a group and increasing this measure as the group independence grows, and conversely, for a non-group claim, determining the liability level of members in the group for a claim originating from a member account which does not form part of the group, based on the independence level of the group, and decreasing the non-group claim liability level of members of the group for the non-group claim as the group independence level grows.

21. (canceled)

22. (canceled)

23. (canceled)

24. (canceled)

25. (canceled)

26. A computer-implemented system for managing a group in a peer-to-peer digital insurance network, the network including a plurality of members each having an electronic member account, wherein the system includes a server, comprising:
a group establishing module for establishing a group which is configured to include a subset of the members of the network;
a group administration module for adding a member of the network to the group by associating the member account of the member with the group; and
a risk factor module for determining, for the member account of the member added to the group, a group risk factor and a network risk factor, a combination of which is used to determine the independence level of the group and thereby the liability of the member account in the event of a claim originating from a member account which forms part of the group, and used to determine liability of the member account in the event of a claim originating from a member account which does not form part of the group,
wherein the risk factor module is configured to adjust the group risk factor and/or the network risk factor of the member of the group in response to another member being added to or leaving the group or network, or in response to a change in risk associated with a member account in the group.

27. (canceled)

28. (canceled)

29. (canceled)

30. (canceled)

31. A computer-implemented method for managing digital groups and claim allocations in digital a peer-to-peer insurance network the digital peer-to-peer network including a plurality of members each having an electronic member account, comprising:
establishing a group comprising a subset of the members of the network, adding a member of the network to the group (new group member) by associating the member account of the new group member (new group member account) with the group;
determining, for the new group member account, a member general risk weighting, a group risk factor adjustment and a network risk factor adjustment, wherein the factor adjustments are used to determine liability of the new group member account in the event of a claim originating from within or outside the group; and
automatically adjusting the group risk factor adjustment and the network risk factor adjustment of the new group member general risk weighting in response to another member being added to or leaving the group or network, or in response to a change in risk associated with a member account in the group.

32. The method of claim 31 wherein the general risk weighting is increased by a group risk factor increase and decreased by a network risk factor decrease to provide an adjusted general risk weighting for the member; and further comprising computing a claim liability portion for the member.

33. The method of claim 31 further comprising, in response to a new member being added to the group, determining a group risk factor and/or a network risk factor for the member account of the new member and adjusting the group risk factor and/or network risk factor of the member account of each other member of the group.
